(19) United States
(12) Patent Application Publication
(10) Pub. No.: US 2020/0161934 A1
(43) Pub. Date: May 21, 2020

(54) ENERGY MANAGEMENT USING A CONVERGED INFRASTRUCTURE

(71) Applicant: Energy Harbors Corporation, Inc., Saratoga, CA (US)

(72) Inventors: Shankar Ramamurthy, Saratoga, CA (US); Robert A. Gingell, Sunnyvale, CA (US)

(21) Appl. No.: 16/747,843

(22) Filed: Jan. 21, 2020

Related U.S. Application Data
(63) Continuation-in-part of application No. 16/378,243, filed on Apr. 8, 2019.
Application No. 16/378,243 is a continuation-in-part of application No. 16/118,886, filed on Aug. 31, 2018.
(60) Provisional application No. 62/795,140, filed on Jan. 22, 2019.
(60) Provisional application No. 62/795,133, filed on Jan. 22, 2019.
(60) Provisional application No. 62/838,992, filed on Apr. 26, 2019.
(60) Provisional application No. 62/916,449, filed on Oct. 17, 2019.
(60) Provisional application No. 62/654,718, filed on Apr. 9, 2018.
(60) Provisional application No. 62/645,859, filed on Mar. 21, 2018.
(60) Provisional application No. 62/679,051, filed on Jun. 1, 2018.
(60) Provisional application No. 62/784,582, filed on Dec. 24, 2018.
(60) Provisional application No. 62/795,140, filed on Jan. 22, 2019.
(60) Provisional application No. 62/795,133, filed on Jan. 22, 2019.
(60) Provisional application No. 62/552,747, filed on Aug. 31, 2017.
(60) Provisional application No. 62/654,718, filed on Apr. 9, 2018.
(60) Provisional application No. 62/654,859, filed on Apr. 9, 2018.
(60) Provisional application No. 62/679,051, filed on Jun. 1, 2018.

(51) Int. Cl. H02K 7/18; H02J 15/00; H02J 3/28

(52) U.S. Cl. CPC H02K 7/1823; H02J 3/28; H02J 15/006

(57) ABSTRACT

Disclosed techniques include energy management using a converged infrastructure. Access to one or more fluid-based energy storage and generation assemblies is obtained, where each assembly comprises a pump-turbine and a pressure vessel. The fluid of the one or more fluid-based energy storage and generation assemblies includes liquid air. The one or more fluid-based energy storage and generation assemblies are connected to an electrical energy storage subsystem, where the connecting includes an energy interconnect. The energy interconnect is performed without an electrical subsystem intermediary. The energy interconnect includes a local electrical grid. Energy is provided to the one or more fluid-based energy storage and generation assemblies. The providing is adjusted based on feedback to the energy control management system. Electrical energy is delivered from the energy interconnect, wherein the delivering is based on an energy control management system executing on one or more processors.

### RELATED APPLICATIONS

This application claims the benefit of U.S. provisional patent applications “Energy Management Using a Converged Infrastructure” Ser. No. 62/795,140, filed Jan. 22, 2019, “Energy Management Using Electronic Flywheel” Ser. No. 62/795,133, filed Jan. 22, 2019, “Energy Transfer Through Fluid Flows” Ser. No. 62/838,992, filed Apr. 26, 2019, and “Desalination Using Pressure Vessels” Ser. No. 62/916,449, filed Oct. 17, 2019.

This application is also a continuation-in-part of U.S. patent application “Energy Storage and Management Using Pumping” Ser. No. 16/378,243 , filed Apr. 8, 2019, which claims the benefit of U.S. provisional patent applications “Modularized Energy Management Using Pooling” Ser. No. 62/654,718, filed Apr. 9, 2018, “Energy Storage and Management Using Pumping” Ser. No. 62/654,859, filed Apr. 9, 2018, “Power Management Across Point of Source to Point of Load” Ser. No. 62/679,051, filed Jun. 1, 2018, “Energy Management Using Pressure Amplification” Ser. No. 62/784,582, filed Dec. 24, 2018, “Energy Management Using a Converged Infrastructure” Ser. No. 62/795,140, filed Jan. 22, 2019, and “Energy Management Using Electronic Flywheel” Ser. No. 62/795,133, filed Jan. 22, 2019.

The U.S. patent application “Energy Storage and Management Using Pumping” Ser. No. 16/378,243, filed Apr. 8, 2019, is also a continuation-in-part of U.S. patent application “Energy Management with Multiple Pressurized Storage Elements” Ser. No. 16/118,886, filed Aug. 31, 2018, which claims the benefit of U.S. provisional patent applications “Energy Management with Multiple Pressurized Storage Elements” Ser. No. 62/552,747, filed Aug. 31, 2017, “Modularized Energy Management Using Pooling” Ser. No. 62/654,718, filed Apr. 9, 2018, “Energy Storage and Management Using Pumping” Ser. No. 62/654,859, filed Apr. 9, 2018, and “Power Management Across Point of Source to Point of Load” Ser. No. 62/679,051, filed Jun. 1, 2018.

Each of the foregoing applications is hereby incorporated by reference in its entirety.

### FIELD OF ART

This application relates generally to energy management and more particularly to energy management using a converged infrastructure.

### BACKGROUND

Energy demand continues to increase due to a variety of factors. This increasing demand is driven by the growth and development of municipalities, counties, states, and countries; increased use of personal electronic gadgets powered by electricity; and improved standards of living. The increases in the living standards in rural areas has required the installation of electrical and communications infrastructure, and the expansion of transportation networks. Growing populations drive energy demand increases as more people consume energy for daily personal tasks that include cooking, bathing, cleaning, laundry, and entertaining. Energy is also consumed for household tasks such as illuminating, heating, and cooling of houses or apartments. Further increases in energy demand are a direct result of expanded economic activities including retail, public transportation, and manufacturing, among many others. Energy producers, government agencies, and responsible consumers strive to initiate, enforce, and practice energy conservation measures, respectively. With respect to consumers, turning off lights when leaving a room, lowering the thermostat in winter or increasing the thermostat in summer, or purchasing energy-efficient appliances are all popular approaches to energy conservation. However, despite concerted conservation efforts, the demand for energy of all types continues to increase beyond what conservation alone has been able to achieve. As towns, cities, states, and countries grow, the demand for energy of all kinds has increased, resulting in what many analysts identify as an energy crisis. The energy demand increases have many root causes. Overconsumption of energy has imposed strains on natural resources ranging from fossil fuels to renewables such as wood chips, resulting in fuel shortages and increased environmental pollution. Population growth and the desire to provide electricity to previously underserved or unserved regions put further strains on energy sources by increasing the numbers of energy consumers. The energy increases also result from expanded economic activities such as manufacturing, transportation, and retail, to name but a few.

Energy distribution problems are frequently identified as a hindrance to solving the energy crisis. Inadequate energy distribution infrastructure and aging energy generation equipment are unable to keep pace with the increased energy demands. Renewable energy options remain largely unexplored or underdeveloped. There is often strong and vociferous resistance by adjacent landowners and others to the siting of mountain or offshore windmills, solar farms, or wood burning plants. Even when plans can be made and permits obtained to construct such energy producing facilities, energy distribution can be stymied by the poor distribution infrastructure. Commissioning of new energy generation facilities remains a seemingly unobtainable objective. Legal wrangling, construction delays, pollution mitigation requirements, overwhelming costs, or even war, have prevented, halted, or delayed new energy generation facilities from coming online. Energy wastage is also a major concern. Aging appliances or manufacturing equipment, incandescent light bulbs, and poor building insulation and air sealing all waste energy in comparison to their modern counterparts.

To meet the many increases in energy demands, national, state, and local public officials, plus city and regional planners, have been faced with deciding among three broader choices: to increase energy production by building new power plants, to reduce energy demand through energy conservation, or to combine both of these strategies. More recently, another emerging option is to source energy production based on renewable energy sources such as solar, wind, geothermal, wave action, and so on. One major limitation of many renewable energy sources is that the sources do not produce consistent amounts of energy 24 hours per day. Solar energy, for one, only produces energy in the presence of light, and produces varying amounts of energy depending on the intensity of the light hitting photovoltaic panels. Energy sources and demands must be balanced so that clean, reliable, and consistent energy is available to all consumers throughout the country.

### SUMMARY

Energy such as electrical energy can be produced by diverse and disparate generation sources. At any given time, multiple generation sources are typically required in order to address differences in energy generation and energy demand. The difference between energy production and energy consumption typically increases or decreases over a given period of time. These differences can further depend on a timeframe such as day versus night, day of the week, manufacturing schedules, seasonal factors such as heating or cooling, and so on. The discrepancies between energy production and consumption can be vast and at times highly critical. The discrepancies can correlate to time-dependent energy demands such as nighttime lighting, changeable energy production capabilities such as the presence or absence of a renewable resource used to generate the energy, the available capacity of commercial or grid power, the amount of standby or backup energy available, etc. The energy production-consumption imbalance can be addressed by storing for later use the available energy that exceeds demand at a given time. The stored energy can be tapped when demand exceeds a given power level. Further, renewable energy can be collected and stored when the renewable resource is available, when the available energy exceeds the needed energy, or even when the cost of production of the energy is relatively inexpensive. The stored energy can be used to augment available energy or to provide the amount of energy that is needed during periods of increased or unmet energy need. The recovery of stored energy can be applied to low-level energy demand scenarios, such as the energy needs of a house or small farm operation, or to larger scale energy needs such as the energy needs for manufacturing, or even to the largest energy needs such as an energy distribution grid.

Disclosed techniques address energy management using a converged infrastructure. Access to one or more fluid-based energy storage and generation assemblies is obtained, where each assembly comprises a pump-turbine and a pressure vessel. The one or more fluid-based energy storage and generation assemblies are connected to an electrical energy storage subsystem, where the connecting includes an energy interconnect. Energy is provided to the one or more fluid-based energy storage and generation assemblies. Electrical energy is delivered from the energy interconnect, wherein the delivering is based on an energy control management system executing on one or more processors. The energy interconnect is performed without an electrical subsystem intermediary. The energy interconnect includes a local electrical grid.

Disclosed embodiments include a computer-implemented method for energy management comprising: obtaining access to one or more fluid-based energy storage and generation assemblies, wherein each assembly comprises a pump-turbine and a pressure vessel; connecting the one or more fluid-based energy storage and generation assemblies to an electrical energy storage subsystem, wherein the connecting includes an energy interconnect; providing energy to the one or more fluid-based energy storage and generation assemblies; and delivering electrical energy from the energy interconnect, wherein the delivering is based on an energy control management system executing on one or more processors.

In embodiments, the energy interconnect is performed without an electrical subsystem intermediary. In embodiments, the energy interconnect includes a local electrical grid. And in some embodiments, fluid of the one or more fluid-based energy storage and generation assemblies includes liquid air. Other embodiments comprise adjusting the providing based on feedback to the energy control management system. In embodiments, the feedback includes energy supply updates or energy demand updates. And in some embodiments, the energy control management system uses supply profiles and demand profiles to adjust the delivering.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for energy management using converged infrastructure.

FIG. 2 is a flow diagram for hot-swapping.

FIG. 3 is a block diagram for energy management.

FIG. 4 illustrates an energy internet block diagram.

FIG. 5 shows a software defined water piston heat engine (WPHE).

FIG. 6 illustrates energy storage and recovery.

FIG. 7 shows a water piston heat engine.

FIG. 8 is a system diagram for energy management using a converged infrastructure.

### DETAILED DESCRIPTION

This disclosure provides techniques for energy management using a converged infrastructure. The energy management is based on obtaining access to one or more fluid-based energy storage and generation assemblies. The fluid-based energy storage and generation assemblies each comprise a pump-turbine and a pressure vessel. The pressure vessel can include a tank, a cavern, a void, a non-productive oil well, etc. The fluid-based energy storage and generation assemblies can be components of a large-scale energy storage subsystem which can store energy from one or more points of generation. The stored energy can be provided after a period of time to meet energy demands of current loads, dynamic loads, seasonal loads, and the like. The energy that is stored can be received from widely diverse and disparate energy sources. Energy can be stored when the amount of energy available from the points of generation exceeds the energy demand at the time of energy generation. The energy can be stored for a period of time. The energy storage can include electrical energy storage using batteries or capacitors. The energy storage can include fluid-based energy storage using a pump-turbine and a pressure vessel. The energy storage can include multiple pressurized storage elements such as compressed air storage elements. The energy storage and generation include the one or more fluid-based energy storage and generation assemblies. The storage of the energy and the generation of the energy can include use of a water piston heat engine (WPHE). Managing the obtaining, the connecting, and the providing of energy is a complex and highly challenging task. Energy management can be influenced by many factors such as seasonal considerations including the weather, variable energy generation pricing schemes, wildly varying energy demand, and so on. Energy management can be further complicated by an expanding energy customer base, quickly changing customer energy demands, requirements of service level agreements (SLAs), energy policies, etc. Despite the growing use of renewable energy resources such as solar, wind, wave action, tidal, geothermal, biogas, and the like, two significant challenges remain: the amount of energy produced by a given renewable energy source is highly variable, and the availability of the renewable energy source is inconsistent. As an example, wind energy is only available when wind is present, solar energy only when the sun is shining, wave action energy only when there is wave action, and so on.

Energy with intermittent availability or energy in excess of present load requirements can be stored or cached when the energy is being produced, and can be extracted and used for energy generation at a later time when the stored energy is needed. A similar strategy can be used based on price, where energy is stored when production cost is low, then later extracted when the energy production cost is high. The stored energy can be used in combination with other energy sources such as grid power or microgrid (local) power to meet energy demands at given times. Storage can include a period of time, where the period of time can be a short-term basis or a long-term basis. Energy losses are introduced when converting energy from one energy type to another energy type. Further losses occur when storing energy, extracting energy, generating energy, routing energy, etc. Minimizing the energy losses is critical to any energy storage and retrieval/recovery technique. Electrical energy storage is possible using techniques such as mature storage battery technologies, but the high costs of large battery banks are prohibitive in terms of up-front cost and maintenance costs. Further, batteries are problematic for long-term storage purposes because of charge leakage.

In disclosed techniques, energy management uses a converged infrastructure. Energy can be obtained locally from a microgrid or from farther afield using a grid. The energy can be derived from conventionally generated sources, renewable sources, etc., and can be stored. The stored energy can be used for energy generation at a later time. The energy can be generated using fuels such as coal, natural gas, or nuclear sources; using hydro power or geothermal energy; using renewable sources such as solar, wind, tidal, wave-action, bio-fuels or biogas; using pump-turbine sources such as compressed air, steam, or ice; or using backup power sources such as diesel-generator (DG) sets; and so on. Access to one or more fluid-based energy storage and generation assemblies is obtained, where each assembly comprises a pump-turbine and a pressure vessel. The fluid-based energy storage and generation assemblies can be parts of a larger energy management system that can include a large-scale energy storage subsystem. The large-scale energy storage subsystem can store electrical energy, potential energy, thermal energy, kinetic energy, chemical energy, etc. The one or more fluid-based energy storage and generation assemblies are connected to an electrical energy storage subsystem, where the connecting includes an energy interconnect. The energy interconnect can connect a variety of energy storage subsystems. The energy interconnect can connect energy storage subsystems without having to convert energy among various energy forms. The energy interconnect can be performed without an electrical subsystem intermediary. The energy interconnect can connect among local energy storage subsystems. The energy interconnect can include a local electrical grid. Energy is provided to the one or more fluid-based energy storage and generation assemblies. The energy can be provided by actuating one or more valves. Electrical energy is delivered from the energy interconnect, wherein the delivering is based on an energy control management system executing on one or more processors. The energy control management system uses supply profiles and demand profiles to adjust the delivering. The energy control management system provides valve control information to the one or more fluid-based energy storage and generation assemblies. The obtaining, the connecting, the providing, and the delivering comprise an energy internet converged infrastructure. In embodiments, the energy internet converged infrastructure enables software-controlled energy delivery optimization.

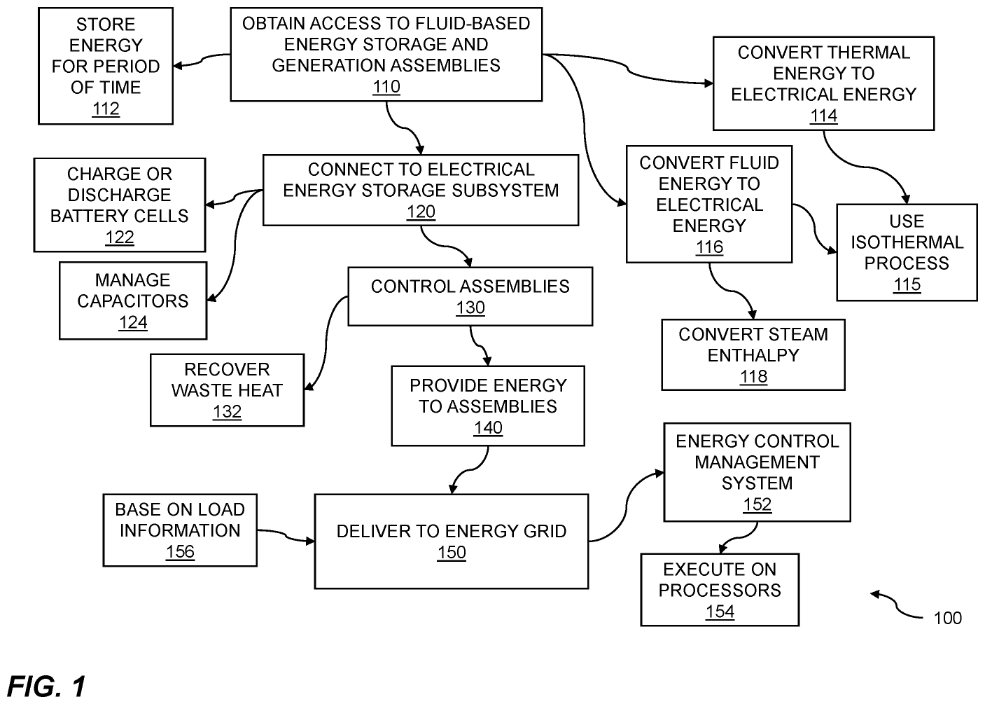

FIG. 1 is a flow diagram for energy management using converged infrastructure. Energy storage and management can be based on one or more assemblies, where the one or more assemblies can include fluid-based energy storage and generation assemblies. The fluid-based energy storage and generation assembly can include a pump-turbine and a pressure vessel. The energy can be stored based on energy transfer such as liquid energy transfer. The liquid can include water, liquid air, and the like. The liquid can be used to compress a gas such as air or nitrogen, a specialty gas such as Freon™, and so on. The liquid can be used to move a liquid such as water to create hydraulic head. The liquid can be moved by the pump-turbine. The liquid in which energy is stored can be used to generate energy. The liquid can be used to spin a turbine, the pump-turbine, and the like. In embodiments, the pump-turbine can generate electrical energy. The fluid-based energy storage and generation assemblies can be parts of a large energy storage and generation subsystem. The energy storage and generation subsystem can include further assemblies for storing energy in other forms. The further energy storage and generation subsystems can include multiple batteries or capacitors, pressurized storage elements such as high-pressure water, pressurized air, steam, ice-water slurry, and the like. Access to one or more fluid-based energy storage and generation assemblies is obtained, where each assembly comprises a pump-turbine and a pressure vessel. The pump-turbine can be a separate pump and a separate turbine. In other embodiments, the pump-turbine can be implemented in combination. The one or more fluid-based energy storage and generation assemblies are connected to an electrical energy storage subsystem, where the connecting includes an energy interconnect. Energy is provided to the one or more fluid-based energy storage and generation assemblies. Electrical energy is delivered from the energy interconnect, wherein the delivering is based on an energy control management system executing on one or more processors.

A flow 100 is shown for energy management using a converged infrastructure. The converged infrastructure can include one or more energy storage and generation subassemblies. The energy storage and generation subassemblies include fluid-based energy storage and generation assemblies. Energy, such as electrical energy obtained from a traditional electrical grid, energy from renewable sources, locally generated energy, and so on, can be stored and used for energy generation. Other forms of energy including thermal energy, mechanical energy, pressure, etc. can be stored. The energy can be transformed into an energy format which can be stored for a length of time, where the length of time can include a short-term basis, a long-term basis, etc. Energy management can be based on one or more energy control policies, energy production costs, service level agreements, energy needs, and the like. An energy management policy can be used for storing, retrieving, generating, or extracting energy from an energy storage assembly. The energy storage assembly can be a large-scale energy storage assembly or can be a small-scale energy storage assembly. While fluid-based energy storage and generation assemblies are discussed throughout, the energy storage assemblies further can be based on battery storage, capacitor storage, inductive storage, compressed air storage, steam or ice storage, ice-water slurry, and so on. The energy storage assemblies can include a pump-turbine and pressure vessel assembly. The pressure vessel can include energy storage elements such as high-pressure chambers, compression-expansion chambers, compressed air chambers, and so on. The pressure vessels can be located above ground, below ground, submerged in water, etc. The pressure vessels can include unused oil infrastructure such as unused or non-productive oil well infrastructure, unused salt caverns, aquifers, large cavities underground, or porous rock structures capable of holding air or water under pressure. The storage elements of an energy storage and generation assembly can store various types of energy including electrical energy, thermal energy, kinetic energy, mechanical energy, hydraulic energy, and so on.

The flow 100 includes obtaining access to one or more fluid-based energy storage and generation assemblies 110, where each assembly comprises a pump-turbine and a pressure vessel. The access to the one or more fluid-based energy storage and generation assemblies can be enabled by a policy, a service level agreement, an energy load, and the like. The pump-turbine can include a pump-turbine subassembly or a pump subassembly and a turbine subassembly. The pump-turbine can consume energy such as electrical energy to spin the turbine. The pump-turbine can be used to move a fluid such as water, where the water can be used to pressurize the pressure vessel. The turbine of the pump-turbine can be spun by a fluid, gas, etc., which in turn can spin the pump. In embodiments, the pump can be used to generate energy such as electrical energy. In embodiments, the pump-turbine can be used to convert energy such as electrical energy to a fluid-based energy that can be stored. The fluid-based energy can include pressure, flow, hydraulic head, etc. In embodiments, the fluid of the one or more fluid-based energy storage and generation assemblies can include liquid air. The fluid can further include water such as ambient water, treated water, etc.

In the flow 100, the one or more fluid-based energy storage and generation assemblies include storing energy for a period of time 112. The period of time for which the energy can be stored can be based on a variety of factors such as when or where the energy is produced, by what means the energy is produced, a possible use for the energy, and the like. In embodiments, the period of time can be a short-term basis. Storing energy for a short-term basis can include storing energy as electrical energy in capacitors, chemical energy in batteries, etc. The storing energy for a short-term basis can include storing energy using a fluid-based energy storage and generation assembly. In embodiments, the short-term basis can be an integer number of seconds, minutes, hours, or days, where the integer number of seconds, minutes, hours, or days comprises a length of time substantially less than one week. The energy storage can include other periods of time. In embodiments, the period of time is a long-term basis. A long-term basis can include storing energy such as thermal energy collected during hot months for use during cold months. In embodiments, the long-term basis can be an integer number of weeks, months, seasons, or years, wherein the integer number of weeks, months, seasons, or years comprises a length of time substantially more than one day.

In the flow 100, the one or more fluid-based energy storage and generation assemblies convert thermal energy to electrical energy 114. The conversion of thermal energy to electrical energy can be based on thermoelectric devices, expanding gases, and so on. As discussed throughout, the one or more fluid-based energy storage and generation assemblies can be controlled. In embodiments, the controlling enables isothermal operation 115 of the one or more fluid-based energy storage and generation assemblies. In the flow 100, the one or more fluid-based energy storage and generation assemblies convert stored fluid energy to electrical energy 116. The conversion of fluid energy to electrical energy can be based on spinning a turbine using the fluid. In embodiments, the converting stored fluid energy to electrical energy includes converting steam enthalpy 118 to electrical energy by using at least one of the one or more fluid-based energy storage and generation assemblies as a steam turbine. The steam turbine can spin a generator or other electrical generation component to produce direct current (DC) energy, alternating current (AC) energy, etc.

The flow 100 includes connecting the one or more fluid-based energy storage and generation assemblies to an electrical energy storage subsystem 120, where the connecting includes an energy interconnect. Discussed throughout, the electrical energy storage subsystem can include a battery-based subsystem, a capacitor-based subsystem, a fluid-based system, and the like. The energy interconnect can include interconnect that can transfer various types of energy. In embodiments, the energy interconnect can be used to transfer fluid energy using a fluid such as water or liquid air among fluid-based energy storage and generation assemblies. The energy that is transferred need not be converted from one energy format to a second energy format. In embodiments, the energy interconnect can be performed without an electrical subsystem intermediary. For example, fluid energy need not be converted to electrical energy in order to support interconnection among energy storage and generation assemblies. In embodiments, the energy interconnect can include a local electrical grid. The local electrical grid can be used to interconnect batteries, capacitors, photovoltaic panels, wind turbines, a diesel-generator set, and the like.

In embodiments, the electrical energy storage subsystem includes one or more batteries. The batteries can include mature technology batteries such as lead-acid batteries, advanced technology batteries such as lithium-iron-phosphate (LiFePO₄), etc. The batteries can be managed. In embodiments, the electrical energy storage subsystem can further include a battery management system. The battery manager can monitor battery health such as battery temperature or charge leakage, can assess battery usage, and so on. In the flow 100, the battery management system can enable charging or discharging battery cells 122 within the one or more batteries. The management of charging or discharging battery cells can include charging or discharging profiles based on the type of battery. The management of charging or discharging can include constant voltage, constant current, etc. In embodiments, the battery management system can provide current control between the electrical energy storage subsystem and the energy grid. In embodiments, the electrical energy storage subsystem includes one or more capacitors. The capacitors can include electrolytic capacitors, supercapacitors, and the like. In embodiments, the electrical energy storage subsystem can further include a capacitor management system for managing the capacitors 124.

The flow 100 includes controlling the one or more fluid-based energy storage and generation assemblies 130 to implement a compressor function, an expander function, or a heat exchanger function. The controlling can include configuring the fluid-based energy storage and generation assemblies, operating the assemblies, and the like. The compressor function can include compressing a gas in a pressure vessel. The compressor function can be used to store energy. The expander function can include expanding a gas in a pressure vessel. The expander function can be used to generate energy. The heat exchanger function can include injecting thermal energy to heat a gas or liquid; or extracting thermal energy to cool the gas or liquid. In the flow 100, the heat exchanger function can include recovering waste heat 132 through a waste-heat recovery subsystem. The controlling of thermal energy can be accomplished using a variety of techniques. In embodiments, the controlling provides a cold water spray to enable cooling during compression. The cold water spray can be used to reduce a risk of overheating, combustion, and so on. In other embodiments, the controlling can provide a hot water spray to add heat during expansion. The providing a hot water spray can be used to keep a subassembly such as a turbine from “icing up” due to water vapor in the expanding gas freezing within the subassembly.

The flow 100 includes providing energy to the one or more fluid-based energy storage and generation assemblies 140. The providing energy can include sourcing energy from an energy grid such as a state-wide or region-wide grid; providing energy from a local grid; and so on. The grid can provide energy such as electrical energy from generation based on coal, oil, natural gas, hydro, or nuclear sources. The energy can include renewable sources such as solar, wind, tidal, wave action, geothermal, and the like. A local grid can include energy sources such as photovoltaic cells, wind turbines, micro-hydro dams, and the like. Discussed shortly, energy management can include an energy management system. In embodiments, the providing can be adjusted based on feedback to the energy control management system. The energy management control system can monitor energy generation, energy storage, energy load requirements, and so on. The energy management system can receive updates. In embodiments, the feedback includes energy supply updates or energy demand updates. The energy supply updates can include energy source availability, stored energy levels, etc. The energy demand updates can include energy loads, seasonal factors, and the like. In embodiments, the energy control management system uses supply profiles and demand profiles to adjust the delivering.

The flow 100 includes delivering electrical energy 150 from the energy interconnect. The delivering electrical energy can include delivering electrical energy to the grid. In the flow 100, the delivering is based on an energy control management system 152. The energy control management system can include software or hardware for controlling the one or more assemblies of the energy storage and generation subsystem. In the flow 100, the energy control management system executes on one or more processors 154. The one or more processors can include processors within the energy infrastructure; remote processors such as servers, grid computers, mesh computers; etc. The delivering electrical energy can include accessing the energy interconnect. The energy control management system can control the providing of the energy using various techniques. In embodiments, the energy control management system provides valve control information to the one or more fluid-based energy storage and generation assemblies. The valves can control the flow of liquid such as water or liquid air, the flow of gas such as air, etc. In other embodiments, the energy control management system provides fluid connection control information to the one or more fluid-based energy storage and generation assemblies.

In addition to valve control, the energy control management system can control connects between and among energy storage and generation assemblies such as fluid-based energy storage and generation assemblies. In embodiments, the energy control management system controls fluid connections within the one or more fluid-based energy storage and generation assemblies. The fluid connections within the one or more fluid-based energy storage and generation assemblies can include a connection from a source liquid such as water to the pump-turbine; a connection from the pump-turbine to the pressure vessel; a connection from the pressure vessel to a storage subassembly; etc. In embodiments, the controlling fluid connections can be accomplished with a flow controller module. The flow controller module can be controlled by the energy control management system. Various types of valves can be used within an assembly. In embodiments, the controlling fluid connections can be performed by electrically-controlled valves. The energy control management system can control the providing of the generated energy to one or more energy loads. In embodiments, the energy control management system can control electrical connections between the one or more fluid-based energy storage and generation assemblies and the energy grid.

In the flow 100, the delivering electrical energy to the energy grid is further based on load information 156 provided to the energy control management system. The load information can be based on instantaneous load (dL/dt), estimated load, seasonally adjusted load, weather-based factors, and the like. The load information can be articulated in a service level agreement (SLA) in which a level of electrical energy delivery is required. In embodiments, the energy control management system is driven by an energy control policy. The energy control policy can be based on cost of energy production, mean time to failure (MTTF) predictions for assemblies within the energy storage and generation subsystem, contractual obligations for levels of energy delivery, etc. In embodiments, the energy control policy changes dynamically. The dynamic changes to the energy control policy can be based on equipment failure, unanticipated load requirements, emergency situations such as a natural disaster or emergency maintenance, etc. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

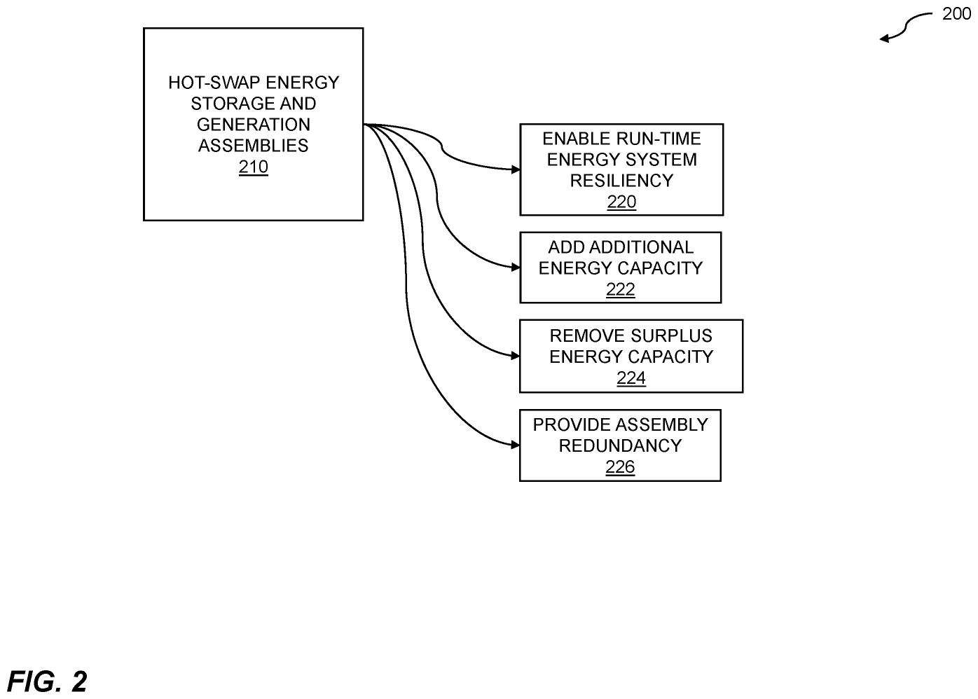

FIG. 2 is a flow diagram for hot-swapping. Energy storage and generation assemblies, such as fluid-based energy storage and generation assemblies, can be added to or removed from an energy infrastructure for a variety of purposes. Energy storage and generation assemblies can be added to meet increased demand or to provide additional energy storage and generation capacity; removed due to reduced demand, scheduled maintenance, equipment replacement, or equipment failure; and so on. Hot-swapping can refer to a system design feature with which one or more energy storage and generation assemblies can be added to or removed from an energy infrastructure without requiring that the energy infrastructure first be shut down. Hot-swapping enables energy management using a converged infrastructure. Access to one or more fluid-based energy storage and generation assemblies is obtained, where each assembly comprises a pump-turbine and a pressure vessel. The one or more fluid-based energy storage and generation assemblies are connected to an electrical energy storage subsystem, where the connecting includes an energy interconnect. The energy interconnect can be performed without an electrical subsystem intermediary, and the energy interconnect can include a local electrical grid. Energy is provided to the one or more fluid-based energy storage and generation assemblies. Electrical energy is provided from the energy interconnect, where the delivering is based on an energy control management system executing on one or more processors.

The flow 200 includes hot-swapping two or more of the fluid-based energy storage and generation assemblies 210. The assemblies can include pressure vessels, pump-turbines, and so on. Other energy storage and generation assemblies can be hot-swappable within an energy infrastructure such as compressed gas, hydraulic head, batteries or capacitors, and so on. The hot-swapping two or more of the energy storage and generation assemblies can be accomplished without shutting down or taking offline the energy storage and generation assemblies. The hot-swapping can be controlled by an energy control management system. The hot-swapping can be accomplished for a variety of energy storage and generation purposes. In the flow 200, the two or more assemblies are hot-swapped to enable run-time energy system resiliency 220. Run-time energy system resiliency can include energy storage and generation expansion or contraction; system upgrade or system maintenance; replacement of failing or failed assemblies, and the like. In the flow 200, the hot-swapping includes adding additional energy capacity 222 during run-time. The adding additional energy capacity can include adding additional fluid-based energy storage and generation assemblies. The adding additional energy capacity can include adding battery or capacitor assemblies, adding renewable energy generation sources, connecting a diesel-generator (DG) set, etc.

In the flow 200, the hot-swapping includes removing surplus energy capacity 224 during run-time. As discussed throughout, the removing additional energy capacity can include disconnecting temporary or backup energy sources; taking assemblies offline for replacement or maintenance; removing surplus energy storage and generation capacity; and the like. In the flow 200, the hot-swapping can provide assembly redundancy 226. Assembly redundancy can be based on SLAs, policies, seasonal factors, etc. The assembly redundancy can be based on cost. The assembly redundancy can include N+1 redundancy, where one additional assembly is available. Other redundancy schemes can include 2N redundancy, where there are two of each required assembly. Hot-swapping two or more of the fluid-based energy storage and generation assemblies can be based on energy delivery requirements. The energy delivery requirements can include seasonal adjustments, service level agreement (SLA) requirements, energy policies, and so on. In embodiments, the delivering electrical energy to the energy grid can be further based on load information provided to the energy control management system. The energy control management system can monitor energy storage and generation capacity, energy load requirements, and so on. In embodiments, the energy control management system can be driven by an energy control policy. The energy control policy can be based on cost of energy production, availability of energy storage and generation assemblies, contractual requirements such as the SLAs, etc. In embodiments, the energy control policy changes dynamically.

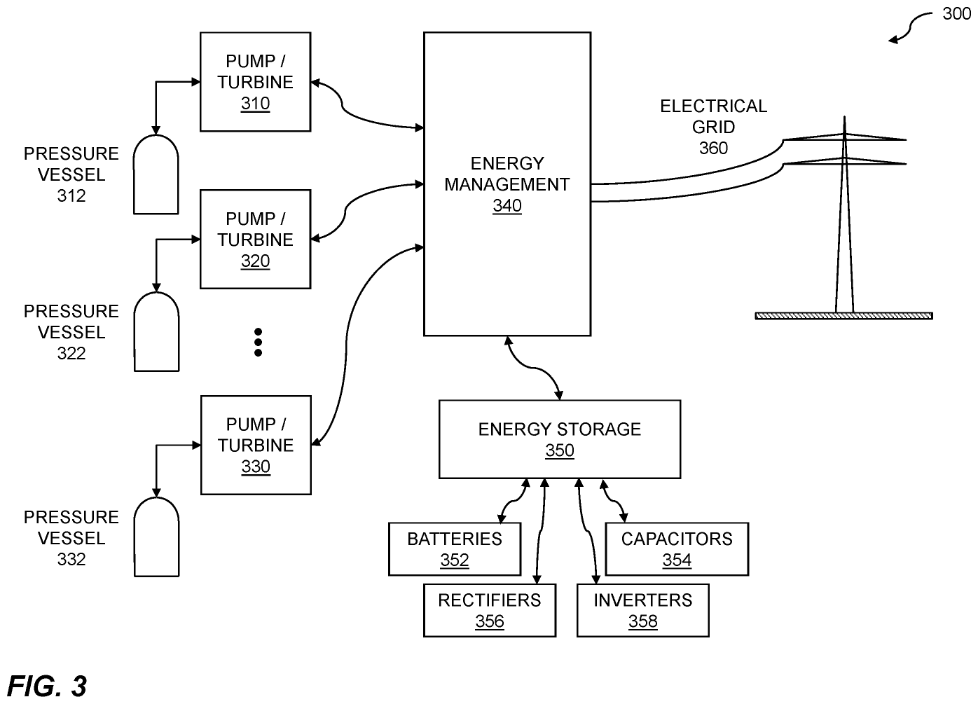

FIG. 3 is a block diagram for energy management. Energy management can use a converged infrastructure. The converged infrastructure can include fluid-based assemblies for energy storage and generation. Access to one or more fluid-based energy storage and generation assemblies is obtained. Each assembly comprises a pump-turbine and a pressure vessel. The one or more fluid-based energy storage and generation assemblies are connected to an electrical energy storage subsystem, where the connecting includes an energy interconnect. The energy interconnect is performed without an electrical subsystem intermediary, and the energy interconnect includes a local electrical grid. Energy is provided to the one or more fluid-based energy storage and generation assemblies, where the providing can be adjusted based on feedback to an energy control management system. Energy is delivered from the energy interconnect. The delivering is based on the energy control management system executing on one or more processors.

Energy management 300 can include one or more pump-turbines, where the pump-turbines can be coupled to pressure vessels. In the block diagram, pump-turbine/pressure vessel assemblies can include a first pump-turbine 310 and pressure vessel 312, a second pump-turbine 320 and pressure vessel 322, a third pump-turbine 330 and pressure vessel 332, and so on. While three pump-turbine/pressure vessel assemblies are shown, other numbers of pump-turbine/pressure vessel assemblies can be used. The pump-turbine/pressure vessel assemblies can be connected to an energy management component 340. The energy management component can include an energy control management system, where the energy control management system can include software that can be executed on one or more processors. Energy management can be coupled to energy storage 350. Various types of energy, such as electrical energy, chemical energy, thermal energy, kinetic energy, potential energy, etc. can be stored. In the block diagram for energy management, energy storage can include batteries 352, capacitors 354, and so on. When the energy being stored is electrical energy, the electrical energy can be converted between direct current electrical energy and alternating current electrical energy. Energy storage can include rectifiers 356 for conversion of electrical energy from alternating current to direct current. Energy storage can further include inverters 358 for conversion of electrical energy from direct current to alternating current. Energy storage can be accomplished using flywheels which can be separate from or included as part of a motor or generator. Energy management can include distributing energy. Energy distribution can include delivering energy such as electrical energy to an electrical grid 360. The electrical grid can include a local grid such as a local grid for a farm, a factory, or a neighborhood; or a larger grid such as a city grid, a state grid, a regional grid, a national grid, etc.

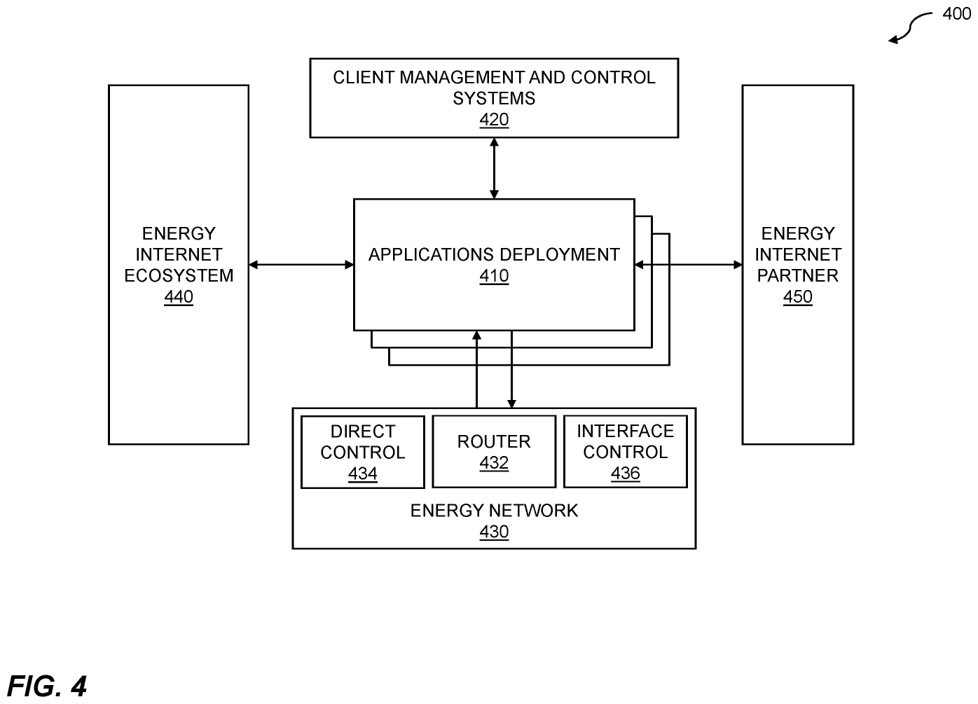

FIG. 4 illustrates an energy internet block diagram. An energy internet 400 enables energy management using a converged infrastructure. An energy internet 400 enables infrastructure convergence by connecting the elements comprising the infrastructure. A converged infrastructure includes any combination of connections of forms of energy, energy generation and storage and use, and information about these to form an energy internet in which energy management occurs. Energy internet infrastructure elements include mechanisms for physical processes such as energy generation, storage, and use; and for the sensing, modeling, and control of energy among the elements in whole or in part; as well as information processing elements which enable modeling, learning, reasoning, and the software-definition of elements through compositions of connections between elements. The connecting of elements occurs between, within, and among the elements comprising the energy internet. The connecting occurs through energy flows that transmit, convert, and control energy generation and use, including the storage of energy. Energy flows contain and communicate information that can be used to sense, model, and control elements and energy flows. Energy flows can employ but are not limited to mechanical energy, electrical energy, solar, wind, tidal, wave-action, combustion, thermal energy, fluid-based energy, radiation, and plasma energy. Access to one or more fluid-based energy storage and generation assemblies is obtained, where each assembly includes a pump-turbine and a pressure vessel. The one or more fluid-based energy storage and generation assemblies are connected to an electrical energy storage subsystem. The connecting includes an energy interconnect, where the energy interconnect is performed without an electrical subsystem intermediary. Energy to the one or more fluid-based energy storage and generation assemblies is provided. Electrical energy from the energy interconnect is delivered, where the delivering is based on an energy control management system executing on one or more processors. The energy internet can include applications deployment 410. The applications deployment for an energy internet can include a cluster, where the cluster includes one or more application programming interfaces (APIs) for handling data, policies, communications, control, and so on. The data can include energy storage, pump-turbine storage, energy from water power, grid energy, etc. The data can include information from energy generators, partners, and so on. The data can further include third-party data from parties including energy consumers such as oil rigs; solar, wind, tidal, or wave-action farms; data centers; and the like.

Applications deployment can communicate with client management and control systems 420. The management can include infrastructure management, microgrid management, operating management, automated controls, and so on. The management can include management of client legacy equipment. The communicating between applications deployment and client management and control systems can include collecting data from one or more points of energy generation, one or more points of energy load, etc. The communicating can further include sending one or more energy control policies. The energy control policies can be based on the energy, energy information, energy metadata, availability of a large-scale energy storage subsystem, and the like. The energy internet can include an energy network 430. The energy network can include one or more energy routers 432, direct control 434, interface control 436, and so on. An energy router 432 can include digital switches for routing energy from a point of energy generation to a point of energy load. An energy router can be coupled to one or more direct control 434 sensors for detecting switch status, point of source status, point of load status, etc. An energy router can be coupled to direct control actuators for steering energy from one or more points of source to a given point of load. An energy router can be further connected to one or more third-party interface control 436 sensors and third-party interface control actuators. The interface control sensors and interface control actuators can be coupled to equipment such as legacy equipment which may not be directly controllable.

The energy internet (EI) can include an energy internet ecosystem 440. The energy internet ecosystem 440 can include a set of services comprised of an energy internet catalog, software, applications, machine-learning algorithms, planning and optimization applications, software-defined machine programming, and so on. The energy internet ecosystem 440 can include entities which own and operate elements of the energy internet. The energy internet ecosystem 440 can include policies governing control of access and information about energy internet elements. Energy internet elements may themselves be compositions of energy internets, energy internet elements, the processes and mechanisms, both physical and logical, implemented by those elements, and so on. The energy internet connections composing the energy internet may be organized as any network topology such as a star, peer-to-peer, or mesh and may exist as one or more energy internet clouds of information-processing and other energy-internet elements. The energy internet organization can vary as needed to provide a balance between economy, reliability, and resiliency. Energy internet services can similarly be variously organized such that a service (e.g. an energy internet catalog) is embodied in a distributed application that operates across changes in the connections from which the energy internet is comprised. Information communicated over the energy internet can be used to provide models for applications governing the operations of the energy internet and its ecosystem as a whole and for the dynamic instantiation of software-defined machines composed through connections of energy internet elements.

The energy internet can include an energy internet cloud, an energy internet catalog, and so on. The energy internet (EI) cloud can include an energy internet secure application programming interface (API) through which the EI cloud can be accessed. The EI ecosystem can include third-party applications such as an application or app store, application development and test techniques, collaboration, assistance, security, and so on. The EI cloud can include an EI catalog. The EI catalog can include technology models, plant and equipment information, sensor and actuator data, operation patterns, etc. The EI catalog, along with other elements of the energy internet, can enable or prevent access to their contents and functions according to security policies that govern them. The EI cloud can include tools or “as a service” applications such as learning and training, simulation, remote operation, and the like. The energy internet can include energy internet partners 450. The EI partners can provide a variety of support techniques including remote management, cloud support, cloud applications, learning, and so on.

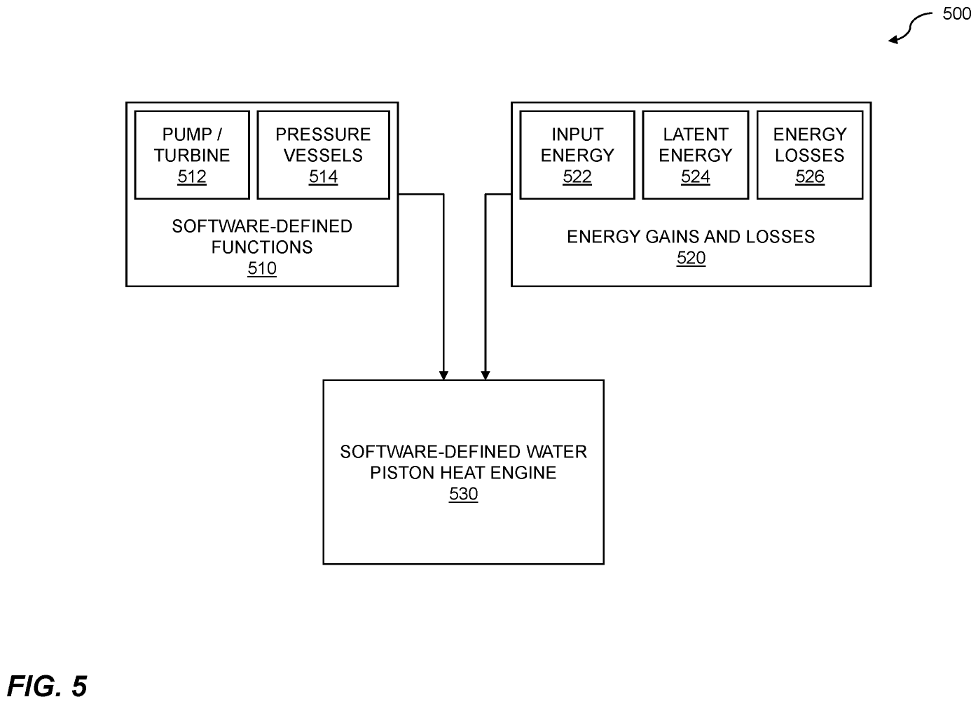

FIG. 5 shows a software-defined water piston heat engine. Energy can be generated, stored, recovered, transformed, delivered, and so on, to meet energy load requirements. Energy storage can be performed when a surplus of energy is being generated from energy sources including renewable energy sources such as wind, solar, tidal, wave-action, and so on. The energy can be stored on a short-term basis, such as a length of time substantially less than one week, or on a long-term basis, such as a length of time substantially more than one day. The energy transforming and delivering can be used for energy management in a converged infrastructure. Access to one or more fluid-based energy storage and generation assemblies is obtained, where each assembly comprises a pump-turbine and a pressure vessel. The one or more fluid-based energy storage and generation assemblies are connected to an electrical energy storage subsystem. The connecting includes an energy interconnect, where the energy interconnect is performed without an electrical subsystem intermediary. Energy is provided to the one or more fluid-based energy storage and generation assemblies. Electrical energy is delivered from the energy interconnect, where the delivering is based on an energy control management system executing on one or more processors.

A software-defined water piston heat engine system 500 is shown. The water piston heat engine includes one or more software-defined functions 510. The one or more software-defined functions can configure or control energy management system components, subsystem components, etc. The software-defined functions can include a pump-turbine function 512. The pump-turbine function can be used to control components such as one or more pumps, one or more turbines, and so on. The pump-turbine function can include one or more pump-turbine subsystems. Embodiments include operating the pump-turbine subsystem at an optimal pressure-performance point for the pump-turbine subsystem. An optimum pressure-performance point can be determined using one or more processors. The pump-turbine function can comprise physical components, moving components, etc. The software-defined functions can include one or more pressure vessels 514. The one or more pressure vessels can be used to store energy within a pressurized fluid, a pressurized gas, and the like. The one or more pressure vessels can include above-ground tanks, below-ground tanks, caverns such as salt caverns, unused oil infrastructure such as unused oil wells, etc.

The water piston heat engine can include energy gains and losses 520. Energy gains can include input energy 522. The input energy can include energy that can be input for storage. The input energy can include grid energy, locally generated energy, renewable energy, and so on. Energy gains can include latent energy 524. Latent energy can be captured from phase changes such as a change from a gas to a liquid, from a liquid to a solid, and so on. The latent energy can be stored. The water piston heat engine can include energy losses. Energy losses 526 can include pressure losses from pressurized vessels, temperature losses, electrical charge leakage, and so on. The system 500 includes a software-defined water piston heat engine (WPHE) 530. The software-defined WPHE can use software to configure the software defined functions, to control energy storage and recovery, and so on. The WPHE can include an energy management system that can be operated by an energy management control system. The energy management control system can add or remove energy generation subsystems or energy storage subsystems as needed. The energy management control system can support hot-swapping of one or more subsystems. Hot-swapping subsystems can include replacing faulty subsystems, swapping out subsystems for maintenance, and the like. In embodiments, the energy management control system can control coupling of the energy, the pump-turbine subsystem, and the one or more pressure amplification pipes. The energy management control system such as the fluid-based energy management system includes storing energy for a period of time. The period of time can include a short-term basis or a long-term basis. In embodiments, the short-term basis can be an integer number of seconds, minutes, hours, or days, wherein the integer number of seconds, minutes, hours, or days comprises a length of time substantially less than one week. Other time increments can be used. In other embodiments, the long-term basis can be an integer number of weeks, months, seasons, or years, wherein the integer number of weeks, months, seasons, or years comprises a length of time substantially more than one day.

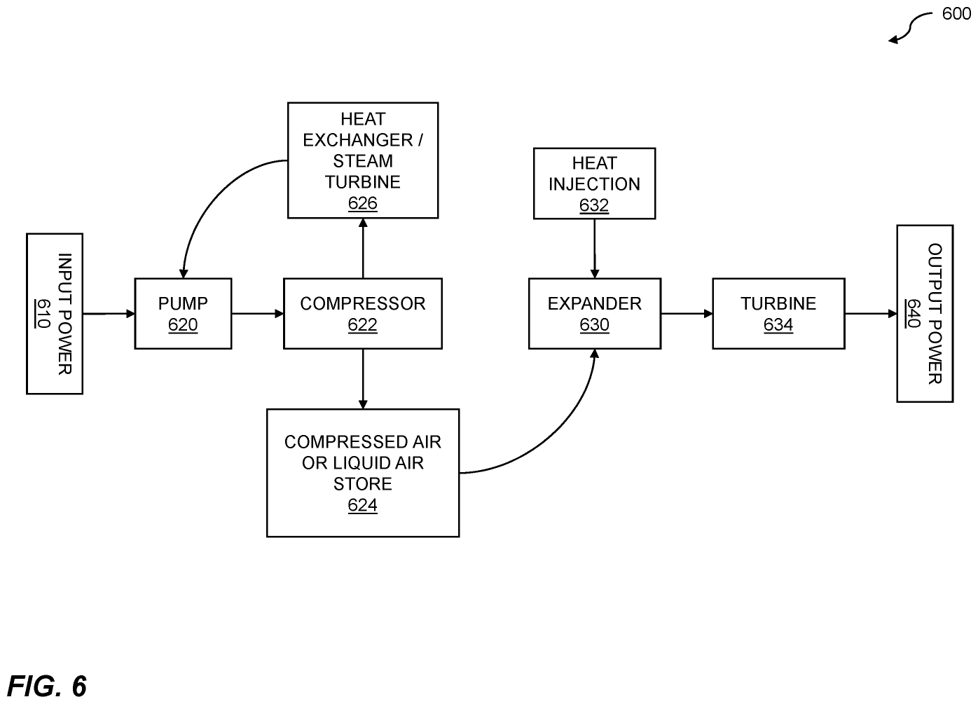

FIG. 6 shows energy storage and recovery 600. Energy management can include controlling energy storage, generation, connection, provision, delivery, and so on. Energy management can include storing energy for a period of time, where the period of time can include a short-term basis, a long-term basis, etc. The stored energy can be recovered and delivered to meet one or more energy load requirements. The energy recovery and delivery can be based on energy load requirements, seasonal adjustments, energy generation and usage policies, service level agreements, and the like. Energy storage and recovery can enable energy management using a converged infrastructure. Access to one or more fluid-based energy storage and generation assemblies is obtained, where each assembly comprises a pump-turbine and a pressure vessel. The one or more fluid-based energy storage and generation assemblies are connected to an electrical energy storage subsystem. The connecting includes an energy interconnect. Energy is provided to the one or more fluid-based energy storage and generation assemblies. Electrical energy is delivered from the energy interconnect, wherein the delivering is based on an energy control management system executing on one or more processors.

Input power 610 can include energy sources such as grid energy from sources that are derived from coal or natural gas, hydro, and nuclear sources; and renewable energy that is derived from sources such as biogas, solar, wind, geothermal, tidal, and wave action. Energy produced from some renewable energy sources can be intermittent. Solar or wind generation relies on the presence of sunlight or wind, respectively. Solar generation is at a minimum on a cloudy day, and substantially zero at night, while wind generation is substantially zero when the wind is calm. Since energy load requirements persist even in the absence of sunlight or wind, for example, energy generated intermittently can be stored. Energy storage can be based on electrical storage, chemical storage, pressure storage, and so on. In embodiments, energy can be stored by using a pump 620. The pump can include an electrically operated pump, a pump driven by a turbine, and the like. The pump can drive a compressor 622 which can be used to store energy in various forms. In embodiments, the compressor can be used to store energy as compressed air or liquid air. The compressed air or the liquid air can be collected in a store 624. The compressor can also be used to generate steam. In embodiments, the compressor can drive a heat exchanger/steam turbine 626. The steam can be used to spin the turbine, which can be used to operate the pump 620. Energy, such as excess heat, including latent heat, can be collected using the heat exchanger. In embodiments, the collected energy can be used to preheat compressed air that can then be used to spin a turbine.

The compressed air or liquid air can be coupled to an expander 630. The expander can be coupled to a turbine 634, where the turbine can be spun by the release of the compressed air. As compressed air expands or is released, the compressed air cools. The result of the cooling air can be to precipitate out any moisture that may be contained within the compressed air. The precipitating moisture can cause the turbine to freeze or ice up due to an accumulation of frost within the turbine. To prevent icing up of the turbine, heat collected by the heat exchanger can be injected 632 into the expander 630. The turbine can be coupled to or can include a generator (not shown). The generator can produce output power 640. The output power can be used to meet increased power load requirements. The output power can be generated from the stored energy, where the stored energy can be generated by the intermittent power sources. The output power can be generated from the stored energy after a period of time that is assigned on a short-term bases or a period of time that is assigned on a long-term basis.

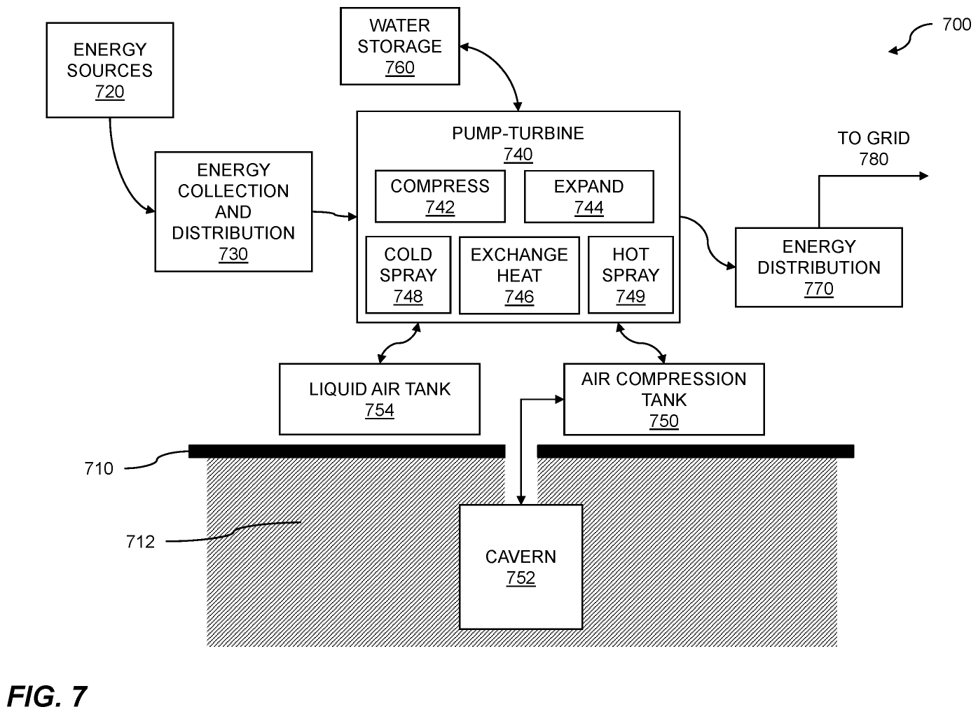

FIG. 7 shows a water piston heat engine. A converged infrastructure (CI) for energy storage and generation can include a variety of components that can be controlled by software. The software can include software-defined functions such as generating, storing, providing, and managing energy. Energy management uses a converged infrastructure. Access to one or more fluid-based energy storage and generation assemblies is obtained, where each assembly comprises a pump-turbine and a pressure vessel. The one or more fluid-based energy storage and generation assemblies are connected to an electrical energy storage subsystem, where the connecting includes an energy interconnect. Energy is provided to the one or more fluid-based energy storage and generation assemblies. Electrical energy is delivered from the energy interconnect, where the delivering is based on an energy control management system executing on one or more processors.

A water piston heat engine (WPHE) 700, or a liquid piston heat engine (LPHE), can be used to convert a liquid or a gas that can be provided by a pump or a pump-turbine to a storage format. The storage formats can include solid, liquid, or gas; heat or cold; and so on. As discussed throughout, the WPHE can transform the input energy to a variety of energy storage formats. The functions of the WPHE can be software defined, where the software can operate the WPHE as a compressor, an expander, a heat exchanger, and the like. The WPHE can be positioned on a surface 710, where the surface can include land 712; a body of water such as the ocean, a lake or pond, a stream; and so on. The WPHE can include energy sources 720. The energy sources can include electrical generation from grid sources that can include oil, coal, natural gas, or nuclear; renewable energy sources such as biogas, solar, wind, hydro, geothermal, tidal, or wave action; and the like. The renewable energy sources may be locally available on a microgrid. The energy sources can be obtained and delivered using energy collection and distribution 730. The energy collection and distribution can include coupling the WPHE to one or more electrical grids, one or more microgrids, etc. The one or more electrical grids, or one or more microgrids, can include redundant energy sources, backup energy sources, and the like.

The energy from the energy sources can be provided to a pump-turbine 740. The pump-turbine can include a separate pump component and a separate turbine component, a combined single component, etc. The pump-turbine can be used to pressurize a pressure vessel, can be rotated by gas or liquid leaving the pressure vessel, and so on. The pump portion of the pump-turbine can use energy such as electrical energy to spin the turbine. The spinning turbine can be used to move gas or liquid into a vessel such as the pressure vessel, to compress a gas, etc. The turbine portion of the pump-turbine can use energy such as flowing liquid, expanding gas, and the like to spin the pump. In embodiments, the pump can be used to generate energy such as electrical energy. The pump-turbine can perform a variety of operations or functions, where the operations or functions can be software defined. In embodiments, the pump-turbine can include a compression function 742. The compression function can compress a gas such as air or nitrogen, a specialty gas such as Freon, etc. The compression function can be accomplished using the pump-turbine, a pump, a turbine, etc. In other embodiments, the pump-turbine can include an expansion function 744. Gas or liquid can be used to spin a turbine, the pump-turbine, and so on. The gas or liquid can be released from the pressure vessel. The pump-turbine can accomplish other operations. In further embodiments, the pump-turbine can include a heat exchanger 746. Thermal energy can be generated by compressing a gas. The thermal energy can be captured using a heat exchanger. The pump-turbine can include a cold spray 748. The cold spray can be used to reduce temperature of the pump-turbine or another component while a gas is being compressed. The pump-turbine can include a hot spray 749. Thermal energy can be absorbed by an expanding gas. The hot spray can be used to inject thermal energy into the pump-turbine or other components to keep them from “freezing up” if water vapor in the gas condenses.

Discussed throughout, the pump-turbine can pressurize a pressure vessel. In embodiments, the pressure vessel can include an air compression tank 750. The air compression tank can store a compressed gas such as air or nitrogen, or a specialty gas such as Freon. The air compression tank can be used to pressurize another tank, cavity, and so on. In embodiments, the air compression tank can be used to pressurize a cavern 752. The cavern can include a void below ground, a capsule positioned underwater, and so on. In other embodiments, the compression tank can be used to pressurize other infrastructure such as unused oil infrastructure. The air compression tank can be used to pressurize unused oil wells. The compression accomplished by the pump-turbine can include one or more liquids. In further embodiments, the energy storage can use liquid air in a liquid air tank 754. Energy can be stored using other liquids. In embodiments, energy can be stored in water storage 760. Water storage can include pumping water to higher elevation to create a fluid head, where the fluid head can be used to spin a turbine for energy generation. The water can be fresh water, salt water, or brackish water. The WPHE can include energy distribution 770. Energy distribution can include distributing energy locally such as around a plant or facility, a farm, a neighborhood, and so on. Energy distribution can include delivering energy from the pump-turbine to a local grid or micro-grid. Energy distribution can include providing energy farther afield. The energy distribution can include providing energy to a grid 780. The grid can include a municipal grid, a state-wide grid, a regional grid, a national grid, etc.

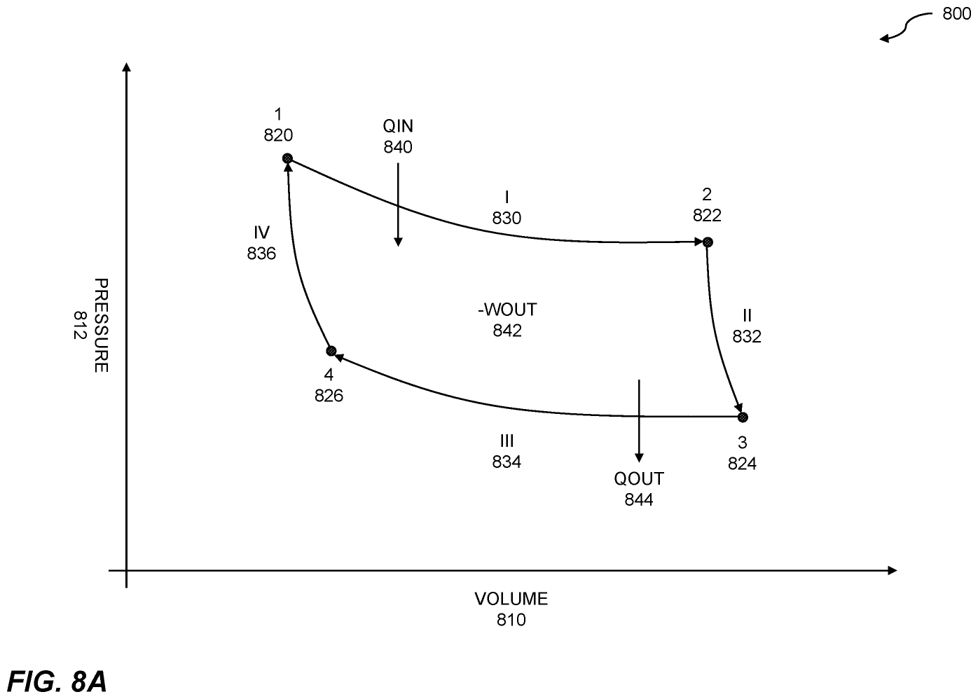

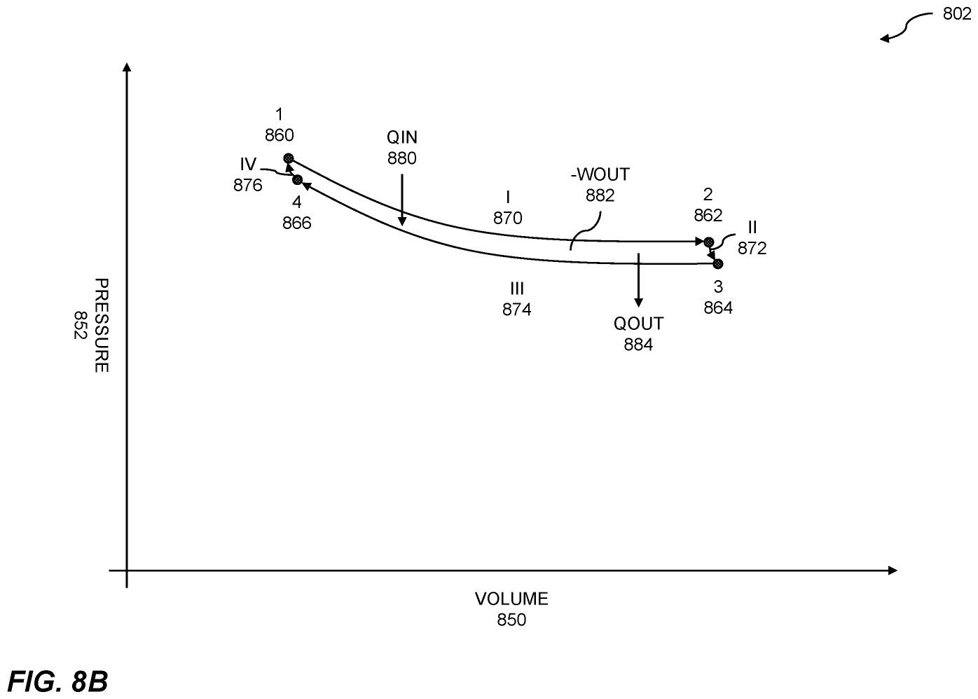

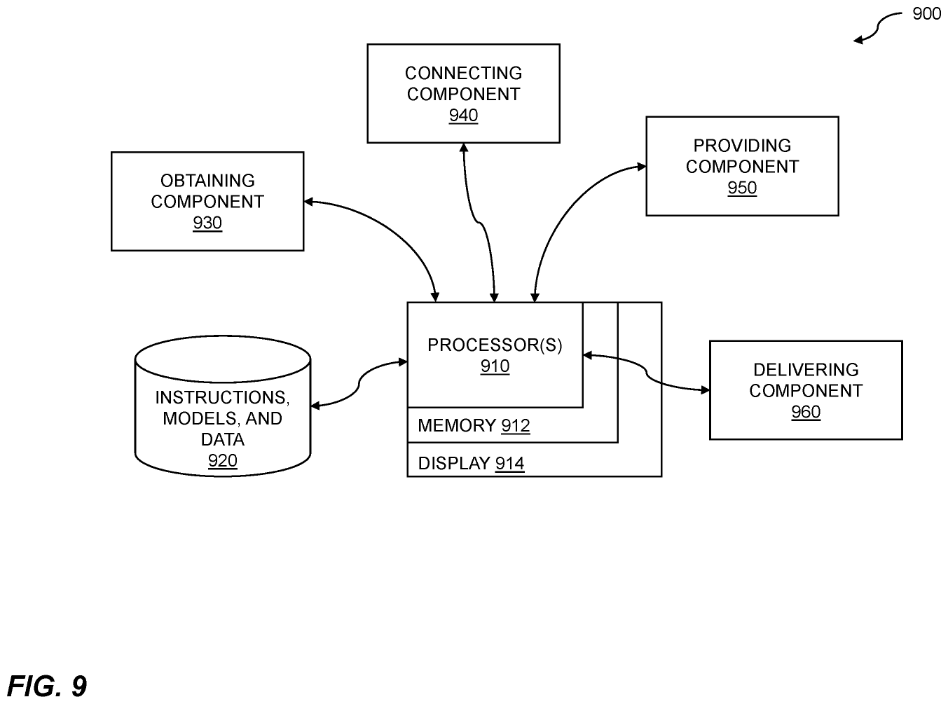

FIG. 8A illustrates adiabicity in a heat transfer cycle. An adiabatic process can occur when neither heat nor mass of a material is transferred between a given thermodynamic system and the environment surrounding the thermodynamic system. “Adiabicity” can describe a quality of the adiabatic process. For the techniques described herein, an adiabatic process with adiabicity equal to zero percent is described as perfectly isothermal, while an adiabatic process with adiabicity equal to 100 percent is described as perfectly adiabatic. Adiabicity in a heat transfer cycle supports energy storage and management using piping. An energy source is connected to a pump-turbine energy management system, where the pump-turbine energy management system includes a pump-energy storage subsystem. Energy from the energy source is stored in the pump-energy storage subsystem. One or more processors are used to calculate a valve-based flow control setting for recovering energy from the pump-energy storage subsystem. One or more valves in the pump-energy management system are energized, where the energizing enables energy recovery. Energy is recovered from the pump-energy storage subsystem using a pump-turbine recovery subsystem enabled by the one or more valves that were energized.

An isothermal adiabatic process can be achieved by adding heat to an endothermic portion of the cycle, such as expansion, and/or extracting heat from an exothermic portion of the cycle, such as compression. Excess heat and excess cooling, both of which would normally be wasted and would move a process out of an isothermal cycle, can be harnessed using a waste-heat recovery subsystem that includes one or more heat exchangers. In embodiments, the one or more heat exchangers enable converting water to steam. The water to steam conversion can be accomplished by spraying cold water into an exothermic process to maintain isothermality in an adiabatic system. In embodiments, the one or more heat exchangers enable converting water to ice. The water to ice conversion can be accomplished by spraying hot water into an endothermic process to maintain isothermality in an adiabatic system. In an adiabatic system, PV^{γ}=k, where P is pressure, V is volume, k is a constant of adiabicity, and gamma (γ) is a volumetric exponent that typically ranges from 1 to 1.4, where γ=1.0 represents an isothermal or near isothermal process and γ=1.4 represents an adiabatic or near adiabatic process. As can be appreciated by one skilled in the art, perfectly isothermal or adiabatic processes are not practiced in typical thermodynamic structures, but processes can nonetheless be referred to as “isothermal” or “adiabatic” when they approach the theoretical limits within 10% to 30%.

The figure shows a pressure-volume (PV) diagram 800. A PV diagram can be used to show changes in pressure 812 versus volume 810 for one or more thermodynamic processes. A cycle, such as a heat transfer cycle, can be based on the one or more thermodynamic processes. One lap around the cycle can complete the cycle, where the completed cycle can result in no net change of system state. With reference to the PV diagram, at the end or completion of the cycle, the thermodynamic system state returns to a pressure and a volume equal to the pressure and the volume of the system at the beginning of the cycle. Four states are shown: state 1 820, state 2 822, state 3 824, and state 4 826. Each state 1 through 4 represents a pressure and a corresponding volume. While four states are shown, other numbers of states may be present for a given cycle. A path between two states can represent a process. Four processes are shown: process I 830, process II 832, process III 834, and process IV 836. While four processes are shown, other numbers of processes may be present within a given cycle.

A given process can affect a system pressure, a system volume, or both a system pressure and a system volume. For the heat transfer cycle shown, the processes can be isothermal such as process I and process III, or adiabatic such as process II and process IV. In general, the four processes shown can include isothermal expansion, such as between points 1 and 2; reversible adiabatic or isentropic expansion, such as between points 2 and 3; reversible isothermal compression, such as between points 3 and 4; and reversible adiabatic or isentropic compression, such as between points 4 and 1. Using the first law of thermodynamics, for a closed system, an amount of internal energy of the closed system can be calculated based on a quantity of input heat, such as input heat qin 840 minus an amount of work performed by the system, such as—wout 842. Any heat removed from the system, such as output heat qout 844 can be determined to be equal to the quantity of input heat minus work.

FIG. 8B illustrates an isothermal heat transfer cycle. A cycle of a thermodynamic system can include one or more thermodynamic processes. The thermodynamic processes can include isothermal processes and adiabatic processes. When the adiabicity of adiabatic processes is nearly equal to zero, then the thermal dynamic system can be described approximately as an isothermal system. An isothermal heat transfer thermodynamic system can support energy storage and management using piping. An energy source is connected to a pump-turbine energy management system. The pump-turbine energy management system includes a pump-energy storage subsystem. Energy from the energy source is stored in the pump-energy storage subsystem. Processors are used to calculate a valve-based flow control setting for recovering energy from the pump-energy storage subsystem. Valves in the pump-energy management system are energized to enable energy recovery. Energy is recovered from the pump-energy storage subsystem using a pump-turbine recovery subsystem enabled by the energized valves.

A pressure-volume (PV) diagram is shown in the FIG. 802. The PV diagram can plot pressure versus volume, and can show one or more states, where each state 1 through 4 comprises a pressure 852 and a corresponding volume 850. Four states are shown: state 1 860, state 2 862, state 3 864, and state 4 866. While four states are shown, other numbers of states may be present for a given cycle. A path between two states can represent a process. A process can include an isothermal process or an adiabatic process. A given process can impact the thermodynamic system by changing pressure, volume, or both pressure and volume. Four processes are shown: process I 870, process II 872, process III 874, and process IV 876. While four processes are shown, other numbers of processes may be present within a given cycle. For the isothermal heat transfer cycle shown, process I and process III can be isothermal. The adiabatic processes, process II and process IV can be as close to zero possible. The adiabatic processes II and IV can have an adiabicity nearly equal to zero. Recall that for a closed thermodynamic system, an amount of internal energy of the closed system can be calculated based on a quantity of input heat, such as input heat qin 880 minus an amount of work performed by the system, such as—wout 882. Any heat removed from the system, such as output heat qout 884 can be determined to be equal to the quantity of input heat minus work.

FIG. 9 is a system diagram for energy management, where the energy management uses a converged infrastructure. Access to one or more fluid-based energy storage and generation assemblies is obtained, where each assembly comprises a pump-turbine and a pressure vessel. The fluid of the one or more fluid-based energy storage and generation assemblies includes liquid air. The one or more fluid-based energy storage and generation assemblies are connected to an electrical energy storage subsystem, where the connecting includes an energy interconnect. The energy interconnect includes a local electrical grid. Energy to the one or more fluid-based energy storage and generation assemblies is provided. The electrical energy is delivered from the energy interconnect, where the delivering is based on an energy control management system executing on one or more processors. The providing is adjusted based on feedback to the energy control management system. The feedback includes energy supply updates or energy demand updates.

The system 900 can include one or more processors 910 and a memory 912 which stores instructions. The memory 912 is coupled to the one or more processors 910, wherein the one or more processors 910 can execute instructions stored in the memory 912. The memory 912 can be used for storing instructions; for storing databases of energy subsystems, modules, or peers for system support; and the like. Information regarding energy management using pressure amplification can be shown on a display 914 connected to the one or more processors 910. The display can comprise a television monitor, a projector, a computer monitor (including a laptop screen, a tablet screen, a netbook screen, and the like), a smartphone display, a mobile device, or another electronic display. The system 900 includes instructions, models, and data 920. The data can include information on energy sources, energy conversion requirements, metadata about energy, and the like. In embodiments, the instructions, models, and data 920 are stored in a networked database, where the networked database can be a local database, a remote database, a distributed database, and so on. The instructions, models, and data 920 can include instructions for obtaining access to one or more fluid-based energy storage and generation assemblies. The instructions, models, and data can further include operating data from a plurality of fluid-based energy storage and generation assemblies, one or more operating goals for the plurality of fluid-based energy storage and generation assemblies, instructions for analyzing operating data, instructions for controlling the operation of energy storage and generation assemblies, etc. Each assembly includes a pump-turbine and a pressure vessel.

The system 900 includes an obtaining component 930. The obtaining component 930 can obtain access to one or more fluid-based energy storage and generation assemblies. The fluid-based energy storage and generation assemblies can be collocated or interconnected. Each assembly comprises a pump-turbine and a pressure vessel. The pump can be powered using an external energy source such as an electrical energy source. The turbine can be spun based on applying a liquid or a gas to the turbine. The fluid-based energy storage can include hot liquids, cold liquids, etc. In embodiments, the fluid of the one or more fluid-based energy storage and generation assemblies can include liquid air. The system 900 includes a connecting component 940. The connecting component 940 can connect the one or more fluid-based energy storage and generation assemblies to an electrical energy storage subsystem. The connecting includes an energy interconnect. In embodiments, the energy interconnect can include a local electrical grid. The local electrical grid can be local to the one or more fluid-based energy storage and generation assemblies. The energy interconnect can include performing the energy interconnect without converting the energy to another form such as an intermediate form. In embodiments, the energy interconnect can be performed without an electrical subsystem intermediary. The energy interconnect can interconnect energy storage and generation assemblies, including fluid-based energy storage and generation assemblies. In embodiments, the energy interconnect can include a local electrical grid.

The system 900 includes a providing component 950. The providing component can provide energy to the one or more fluid-based energy storage and generation assemblies. The energy that can be provided can be obtained from a variety of energy sources such as grid energy sources including coal, natural gas, or nuclear; renewable energy sources including biogas, wind, solar, tidal, or wave action; and so on. The grid energy, renewable energy, etc., can be used to operate a pump-turbine, where the pump-turbine can transfer a gas or liquid, compress a gas, and the like. The providing can be controlled or adjusted. The system 900 includes a delivering component 960. The delivering component can deliver electrical energy from the energy interconnect. The electrical energy can result from operating the pump-turbine. The delivering is based on an energy control management system executing on one or more processors. The one or more processors of the energy management system can execute instructions, models, energy policies, and so on. The energy management system can adjust an amount of energy that is provided. In embodiments, the providing can be based on feedback to the energy control management system. The feedback can include available energy supply, energy consumption requirements, seasonal factors, etc. In embodiments, the feedback can include energy supply updates or energy demand updates, where the updates can be based on sampling. The providing energy can be based on profiles. In embodiments, the energy control management system can use supply profiles and demand profiles to adjust the delivering.

Disclosed embodiments can include a computer program product embodied in a non-transitory computer readable medium for energy management, the computer program product comprising code which causes one or more processors to perform operations of: obtaining access to one or more fluid-based energy storage and generation assemblies, wherein each assembly comprises a pump-turbine and a pressure vessel; connecting the one or more fluid-based energy storage and generation assemblies to an electrical energy storage subsystem, wherein the connecting includes an energy interconnect; providing energy to the one or more fluid-based energy storage and generation assemblies; and delivering electrical energy from the energy interconnect, wherein the delivering is based on an energy control management system executing on one or more processors. Embodiments include a computer system for energy management comprising: a memory which stores instructions; one or more processors attached to the memory wherein the one or more processors, when executing the instructions which are stored, are configured to: obtain access to one or more fluid-based energy storage and generation assemblies, wherein each assembly comprises a pump-turbine and a pressure vessel; connect the one or more fluid-based energy storage and generation assemblies to an electrical energy storage subsystem, wherein the connecting includes an energy interconnect; provide energy to the one or more fluid-based energy storage and generation assemblies; and deliver electrical energy from the energy interconnect, wherein the delivering is based on an energy control management system executing on one or more processors.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for energy management comprising:
obtaining access to one or more fluid-based energy storage and generation assemblies, wherein each assembly comprises a pump-turbine and a pressure vessel;
connecting the one or more fluid-based energy storage and generation assemblies to an electrical energy storage subsystem, wherein the connecting includes an energy interconnect;
providing energy to the one or more fluid-based energy storage and generation assemblies; and
delivering electrical energy from the energy interconnect, wherein the delivering is based on an energy control management system executing on one or more processors.

2. The method of claim 1 wherein the energy interconnect is performed without an electrical subsystem intermediary.

3. The method of claim 1 wherein the energy interconnect includes a local electrical grid.

4. The method of claim 1 wherein fluid of the one or more fluid-based energy storage and generation assemblies includes liquid air.

5. The method of claim 1 further comprising adjusting the providing based on feedback to the energy control management system.

6. The method of claim 5 wherein the feedback includes energy supply updates or energy demand updates.

7. The method of claim 1 wherein the energy control management system uses supply profiles and demand profiles to adjust the delivering.

8. The method of claim 1 wherein the energy control management system provides valve control information to the one or more fluid-based energy storage and generation assemblies.

9. (canceled)

10. The method of claim 1 further comprising controlling the one or more fluid-based energy storage and generation assemblies to implement a compressor function, an expander function, or a heat exchanger function.

11. The method of claim 10 wherein the heat exchanger function enables recovering waste heat through a waste-heat recovery subsystem.

12. The method of claim 10 wherein the controlling provides a cold water spray to enable cooling during compression.

13. The method of claim 10 wherein the controlling provides a hot water spray to add heat during expansion.

14. The method of claim 10 wherein the controlling enables isothermal operation of the one or more fluid-based energy storage and generation assemblies.

15. (canceled)

16. The method of claim 1 wherein the one or more fluid-based energy storage and generation assemblies convert stored fluid energy to electrical energy.

17. The method of claim 16 wherein conversion of stored fluid energy to electrical energy comprises converting steam enthalpy to electrical energy by using at least one of the one or more fluid-based energy storage and generation assemblies as a steam turbine.

18. The method of claim 1 wherein the energy control management system controls fluid connections within the one or more fluid-based energy storage and generation assemblies.

19-20. (canceled)

21. The method of claim 1 wherein the energy control management system controls electrical connections between the one or more fluid-based energy storage and generation assemblies and an energy grid.

22. The method of claim 1 wherein the electrical energy storage subsystem includes one or more batteries.

23. The method of claim 22 wherein the electrical energy storage subsystem further includes a battery management system.

24. (canceled)

25. The method of claim 23 wherein the battery management system provides current control between the electrical energy storage subsystem and an energy grid.

26. (canceled)

27. The method of claim 1 wherein the obtaining, the connecting, the providing, and the delivering comprise an energy internet converged infrastructure.

28. The method of claim 27 wherein the energy internet converged infrastructure enables software-controlled energy delivery optimization.

29-32. (canceled)

33. The method of claim 1 wherein the energy control management system is driven by an energy control policy.

34. The method of claim 33 wherein the energy control policy changes dynamically.

35-39. (canceled)

40. A computer program product embodied in a non-transitory computer readable medium for energy management, the computer program product comprising code which causes one or more processors to perform operations of:
obtaining access to one or more fluid-based energy storage and generation assemblies, wherein each assembly comprises a pump-turbine and a pressure vessel;
connecting the one or more fluid-based energy storage and generation assemblies to an electrical energy storage subsystem, wherein the connecting includes an energy interconnect;
providing energy to the one or more fluid-based energy storage and generation assemblies; and
delivering electrical energy from the energy interconnect, wherein the delivering is based on an energy control management system executing on one or more processors.

41. A computer system for energy management comprising:
a memory which stores instructions;
one or more processors attached to the memory wherein the one or more processors, when executing the instructions which are stored, are configured to:
obtain access to one or more fluid-based energy storage and generation assemblies, wherein each assembly comprises a pump-turbine and a pressure vessel;
connect the one or more fluid-based energy storage and generation assemblies to an electrical energy storage subsystem, wherein the connecting includes an energy interconnect;
provide energy to the one or more fluid-based energy storage and generation assemblies; and
deliver electrical energy from the energy interconnect, wherein the delivering is based on an energy control management system executing on one or more processors.
